(19) United States
(12) Patent Application Publication
(10) Pub. No.: US 2007/0136615 A1
(43) Pub. Date: Jun. 14, 2007

(54) System and method for reducing power used to execute application program

(75) Inventors: Donghwan Son, Daejeon-city (KR); Jung Hee Lee, Daejeon-city (KR); Hyung Seok Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/635,203

(22) Filed: Dec. 7, 2006

(30) Foreign Application Priority Data
Dec. 8, 2005 (KR) 10-2005-0119303
Sep. 29, 2006 (KR) 10-2006-0096627

(51) Int. Cl. G06F 1/00

(52) U.S. Cl. 713/300

(57) ABSTRACT

Provided is a system and method of controlling power, the system and method capable of predicting optimal speeds of operation clocks of a central processing unit (CPU) and a memory used to execute an application program, thereby reducing power used to execute the application program. The system for controlling power includes a requirement prediction module predicting a requirement of central processing unit (CPU) performance and a requirement of memory usage for executing the application program; an operation clock determining unit determining optimal speeds of operation clocks of the CPU and the memory for executing the application program based on the requirements; and a clock speed/driving voltage generating unit generating optimal speeds of the operation clocks and optimal driving voltages of the CPU and the memory for executing the application program based on the determined optimal speeds of the operation clocks.

### CROSS-REFERENCE TO RELATED PATENT APPLICATION

This application claims the benefit of Korean Patent Application No. 10-2005-0119303, filed on Dec. 8, 2005 and Korean Patent Application No. 10-2006-0096627, filed on Sep. 29, 2006, in the Korean Intellectual Property Office, the disclosures of which are incorporated herein in their entirety by reference.

### BACKGROUND OF THE INVENTION

1. Field of the Invention

The present invention relates to a system and method for reducing power used to execute an application program, and more particularly, to a system and method capable of predicting optimal speeds of operation clocks of a CPU (central processing unit) and a memory used to execute an application program, so that it is possible to minimize power consumption for executing the application program.

2. Description of the Related Art

Power consumption for executing an application program in a digital device including a mobile device occupies a large proportion of the total power consumption of the digital device due to a complexity of operation of the program and an increase in the number of built-in systems. The power consumption is proportional to a clock speed of a processor performing operations of the application program and to the square of a driving voltage of the processor.

Therefore, in order to reduce the power consumption of the processor. Reducing the driving voltage of the processor can be the most effective method. However, when the driving voltage is reduced, the clock speed of the processor is also reduced in proportion thereto. Therefore, there is a problem in that the system performance decreases. Namely, the method of reducing the driving voltage is effective to reduce the power consumption. However, to simply lower the driving voltage may cause the decrease in the system performance. Therefore, a method in which the decrease in the system performance is minimized and power consumption is reduced is required.

In relation to the method of reducing power consumption, a dynamic voltage scaling (DVS) is introduced. In this method, there is a trade-off between the system performance and the power consumption to allow a voltage scheduler to change the driving voltage of the processor according to run-time, so that the power consumption can be reduced.

In order to minimize the effect on the system performance, and simultaneously, in order to minimize the power consumption by performing the DVS, CPU usage and memory usage of the application program have to be accurately predicted to apply an appropriate clock speed and driving voltage. However, in the power control method, the system usage is analyzed based only on previous usage and a workload of the CPU. Therefore, there is a problem in that it is difficult to accurately predict usage in an application program of which the workload can change greatly.

### SUMMARY OF THE INVENTION

The present invention provides a system and method for reducing power used to execute an application program, the system and method capable of predicting CPU usage and memory usage of the application program and determining optimal speeds of operation clocks of the CPU and the memory, so that it is possible to minimize power consumption for executing the application program.

According to an aspect of the present invention, there is provided a system for reducing power including: a requirement prediction module predicting a requirement of central processing unit (CPU) performance and a requirement of memory usage for executing the application program; an operation clock determining unit determining optimal speeds of operation clocks of the CPU and the memory for executing the application program based on the requirements; and a clock speed/driving voltage generating unit generating optimal speeds of the operation clocks and optimal driving voltages of the CPU and the memory for executing the application program based on the determined optimal speeds of the operation clocks.

According to another aspect of the present invention, there is provided a method of reducing power including: predicting a requirement of CPU performance and a requirement of memory usage for executing the application program; determining optimal speeds of operation clocks of the CPU and the memory for executing the application program based on the requirements; generating optimal speeds of the operation clocks and optimal driving voltages of the CPU and the memory for executing the application program based on the determined optimal speeds of the operation clocks.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing a processor for determining optimal speeds of operation clocks to supply to a CPU and a memory for executing an application program according to an embodiment of the present invention;

FIG. 2A is a block diagram for illustrating a structure of a system for reducing power used to execute an application program according to an embodiment of the present invention; and

FIG. 2B is a flowchart for illustrating a method of reducing power used to execute an application program according to an embodiment of the present invention.

### DETAILED DESCRIPTION OF THE PREFERRED EMBODIMENT

In order to gain a sufficient understanding of the present invention, an exemplary situation applying the present invention is described.

An application programs includes a usage prediction module which can predict central processing unit (CPU) usage and memory usage (workload) of the program. More specifically, the application programs can include information on usage and performance requirements of the CPU and the memory, and a driving voltage can be effectively controlled based on the usage information predicted by the usage prediction module and by performing a dynamic voltage scaling (DVS).

Therefore, the present invention provides a method in which usage and performance requirements of a CPU and a memory for application programs are predicted, and clock speeds of the CPU and the memory are dynamically changed referring to the predicted performance requirements, so that power consumption used in operation of the application programs can be minimized.

In some processors, the CPU and the memory of a system can be implemented in a single chip to share a single clock generator. In this case, a CPU clock speed and a memory clock speed are linked. For example, in the processor, the CPU and the memory clock speeds may have combinations as follows.

TABLE

| | 1 | 2 | 3 | 4 | 5 | 6 | 7 | 8 | 9 |
|---|---|---|---|---|---|---|---|---|---|
| CPU | 100 | 140 | 150 | 172 | 200 | 210 | 265 | 340 | 400 |
| clock | | | | | | | | | |
| speed | | | | | | | | | |
| memory | 50 | 72 | 76 | 83 | 100 | 50 | 72 | 88 | 100 |
| clock | | | | | | | | | |
| speed | | | | | | | | | |

As above table, a single memory clock speed may be linked to two or more CPU clock speeds. The present invention provides a method in which an appropriate combination of clock speeds is searched according to usage and performance requirements of the CPU and the memory in order to minimize a decrease in the performance of the application program and reduce the power consumption.

Hereinafter, exemplary embodiments of the present invention will be described in detail with reference to the attached drawings. Like reference numerals in the drawings denote like elements.

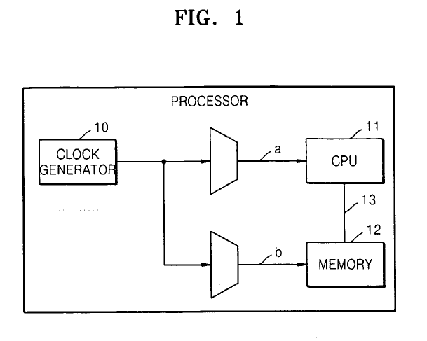

FIG. 1 is a diagram showing a processor for determining optimal speeds of operation clocks to supply to a CPU and a memory for executing an application program according to an embodiment of the present invention.

Referring to FIG. 1, the processor includes a clock generator 10 for generating operation clocks a and b of a CPU 11 and a memory 12, respectively. The CPU operation clock a and the memory operation clock b are supplied by the single clock generator 10 to be linked to each other. The CPU 11 and the memory 12 are connected via a system bus 13. Alternatively, the CPU 11 and the memory 12 may be separately supplied with operation clocks by different clock generators. However, recently, more highly integrated circuits have been used, so that the clocks may be supplied by a single clock generator.

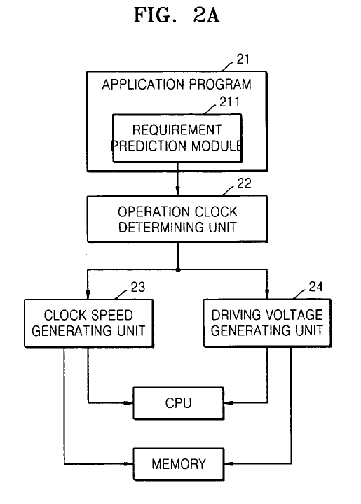

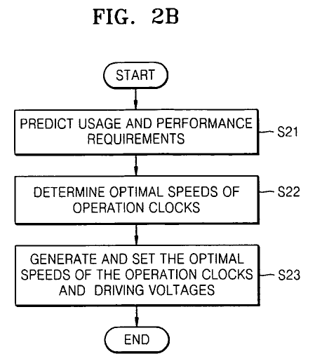

FIG. 2A is a block diagram for illustrating a structure of a system for reducing power used to execute an application program according to an embodiment of the present invention. FIG. 2B is a flowchart for illustrating a method of reducing power used to execute an application program according to an embodiment of the present invention.

Referring to FIGS. 2A and 2B, an application program 21 configured in a user layer of a digital device includes a requirement prediction module 211 which can predict a requirement of CPU performance and a requirement of memory usage including CPU usage and memory usage (workload) of the application program 21. The requirement prediction module 211 predicts a requirement of the CPU performance and a requirement of the memory usage of the application program 21 (operation S21), and transmits the requirements to an operation clock determining unit 22 configured in a kernel layer. Here, the operation clock determining unit 22 may be configured in the user layer, not in the kernel layer.

The operation clock determining unit 22 determines optimal clock speeds of the CPU and the memory used to execute the application program 21 based on the predicted requirements of the usage and the performance received from the requirement prediction module 211 in the application program 21 (operation S22). Here, when the CPU and the memory are supplied with the operation clocks by a single clock generator, the clock speeds of the CPU and the memory may have combinations as shown in Table to be linked to each other.

Here, the possible combinations are set in advance according to systems and are stored in the operating system as a data structure, and the clock speeds are determined from the possible combinations. When the CPU and the memory are supplied with the operation clocks by different clock generators, the clock speeds of the CPU and the memory may be independently set without any link between the clock speeds.

A clock speed generating unit 23 and a driving voltage generating unit 24 generate optimal clock speeds and driving voltages, respectively, to execute the application program 21, based on the determined speeds of the operation clocks, and apply the generated clock speeds and the generated driving voltages to the CPU and the memory (operation S23). In this case, when the application program 21 is executed by using the optimal clock speeds of the CPU and the memory, a quality of service (QOS) similar to that in execution of the application program 21 by using the maximum clock speeds is provided so that a user cannot notice a change in performance of the application program 21.

The present invention uses information on CPU usage and memory usage (workload) and performance requirements that are predicted by the application program, so that a problem with the conventional power control method, in which power control efficiency of an application program which mainly uses a memory is lower than power control efficiency of an application program which mainly uses a CPU, is solved. As a result, the workload and the performance requirements of the application program are properly applied to practice, so that power and performance efficiency can be increased by implementing dynamic voltages and by dynamically changing operation clock speeds.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for reducing power used to execute an application system, the system comprising:
a requirement prediction module predicting a requirement of central processing unit (CPU) performance and a requirement of memory usage for executing the application program;
an operation clock determining unit determining optimal speeds of operation clocks of the CPU and the memory for executing the application program based on the requirements; and
a clock speed/driving voltage generating unit generating optimal speeds of the operation clocks and optimal driving voltages of the CPU and the memory for executing the application program based on the determined optimal speeds of the operation clocks,
wherein the system is operated to reduce power used to execute the application program.

2. A method of reducing power used to execute an application program, the method comprising:
predicting a requirement of CPU performance and a requirement of memory usage for executing the application program;
determining optimal speeds of operation clocks of the CPU and the memory for executing the application program based on the requirements; and
generating optimal speeds of the operation clocks and optimal driving voltages of the CPU and the memory for executing the application program based on the determined optimal speeds of the operation clocks,
wherein the method is used to reduce power used to execute the application program.

3. A computer-readable medium having embodied thereon a computer program for the method of claim 2.
